(19) United States
(12) Patent Application Publication
(10) Pub. No.: US 2016/0369204 A1
(43) Pub. Date: Dec. 22, 2016

(54) METHOD OF MAKING PERFUMED GOODS

(71) Applicant: The Procter & Gamble Company, Cincinnati, OH (US)

(72) Inventor: David Thomas STANTON, Hamilton, OH (US)

(21) Appl. No.: 14/744,371

(22) Filed: Jun. 19, 2015

(51) Int. Cl. C11B 9/00; C11D 3/50

(52) U.S. Cl. CPC C11B 9/00; C11D 3/50

(57) ABSTRACT

The present invention relates to methods of designing and making perfumed products and perfume raw materials for use in products and perfume raw materials selected by such methods and the use of same.

### FIELD OF THE INVENTION

The present invention relates to methods of designing and making perfumed products and perfume raw materials for use in products and perfume raw materials selected by such methods and the use of same.

### BACKGROUND OF THE INVENTION

Perfumed products are typically designed and/or formulated using empirical methods or basic modeling methodologies. Such efforts are time consuming, expensive and, in the case of empirical methodologies, generally do not result in optimum designs/formulations as not all components and parameters can be considered. Furthermore, aspects of such methods may be limited to existing components. Thus, there is a need for an effective and efficient methodology that obviates the short comings of such methods. The modeling systems described herein meet the aforementioned need as they can be used to determine the odor detection threshold of perfume raw materials that can be used to produce new and superior perfumed products. In addition, such modeling systems are faster and more efficient.

### SUMMARY OF THE INVENTION

The present invention relates to methods of designing and making perfumed products and perfume raw materials for use in products and perfume raw materials selected by such methods and the use of same.

### DETAILED DESCRIPTION OF THE INVENTION

### Definitions

As used herein “product” means a perfume delivery system and/or a consumer product.

As used herein “consumer products” includes, unless otherwise indicated, articles, baby care, beauty care, fabric & home care, family care, feminine care, health care, snack and/or beverage products or devices intended to be used or consumed in the form in which it is sold, and is not intended for subsequent commercial manufacture or modification. Such products include but are not limited to home decor, batteries, diapers, bibs, wipes; products for and/or methods relating to treating hair (human, dog, and/or cat), including bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, pet health and nutrition, and water purification; processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); and coffee and cleaning and/or treatment compositions.

As used herein, the term “cleaning and/or treatment composition” includes, unless otherwise indicated, tablet, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, the term “situs” includes paper products, fabrics, garments and hard surfaces.

As used herein, the articles “a”, “an”, and “the” when used in a claim, are understood to mean one or more of what is claimed or described.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Products

A method comprising:
a.) using an ODT value determined by mathematical modelling to select one or more perfume raw materials;
b.) combining and/or processing said one or more perfume raw materials with one or more additional materials to form a product.
   is disclosed.

In one aspect, said product is a consumer product.

In one aspect, said mathematical modelling comprises a technique selected from the group consisting of multiple linear regression, genetic function method, generalized simulated annealing, principal components regression, non-linear regression, projection to latent structures regression, neural networks, support vector machines, logistic regression, ridge regression, cluster analysis, discriminant analysis, decision trees, nearest-neighbor classifier, molecular similarity analysis, and combinations thereof.

In one aspect, said mathematical modelling comprises a technique selected from the group consisting of multiple linear regression, genetic function method, generalized simulated annealing, principal components regression, non-linear regression, projection to latent structures regression, neural networks, support vector machines, logistic regression, ridge regression and combinations thereof.

In one aspect, said mathematical modelling comprises a technique selected from the group consisting of non-linear regression, projection to latent structures regression, neural networks and combinations thereof.

In one aspect, said mathematical modelling comprises neural networks.

In one aspect, said mathematical modelling comprises entering molecular descriptors into a neural network.

In one aspect, said mathematical modelling provides an ODT value that is a numerical value having units of volume/volume.

In one aspect, said mathematical modelling is sufficiently accurate to provide an ODT value of 1 ppb or greater.

In one aspect, said mathematical modelling is sufficiently accurate to provide an ODT value of 1 ppb or less.

In one aspect, said mathematical modelling uses the source code ODTNeuralNetworks and ODTNeuralNetworksDescriptors.

In one aspect, said one or more additional materials is selected from the group consisting of surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume and perfume delivery systems, structure elasticizing agents, thickeners/structurants, fabric softeners, carriers, hydrotropes, oligoamines, processing aids, hueing agents, pigments and mixtures thereof.

In one aspect, said consumer product is selected from the group consisting of , baby care, beauty care, fabric & home care, family care, feminine care, health care, snack and/or beverage products or devices.

In one aspect, a consumer product produced by any method disclosed herein is disclosed method.

### Additional Materials for Products

While not essential for the purposes of the present invention, the non-limiting list of materials illustrated hereinafter are suitable for use in the instant products and may be desirably incorporated in certain embodiments of the invention, for example to assist or enhance cleaning performance, for treatment of the substrate to be cleaned, or to modify the aesthetics of the cleaning composition as is the case with colorants, dyes or the like. The precise nature of these additional components, and levels of incorporation thereof, will depend on the physical form of the product and the nature of the operation for which it is to be used. Suitable adjunct materials include, but are not limited to, surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume and perfume delivery systems, structure elasticizing agents, thickeners/structurants, fabric softeners, carriers, hydrotropes, oligoamines, processing aids, hueing agents, pigments.

As stated, not all of the aforementioned materials are required for the aforementioned products. Thus, certain embodiments of Applicants' products do not contain one or more of the following materials: surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume and perfume delivery systems, structure elasticizing agents, thickeners/structurants, fabric softeners, carriers, hydrotropes, oligoamines, processing aids, hueing agents, pigments. However, when one or more of said materials are present, such one or more materials may be present as detailed below:

### Bleaching Agents

Bleaching agents other than bleaching catalysts include photobleaches, bleach activators, hydrogen peroxide, sources of hydrogen peroxide, preformed peracids. Examples of suitable bleaching agents include anhydrous sodium perborate (mono or tetra hydrate), anhydrous sodium percarbonate, tetraacetyl ethylene diamine, nonanoyloxybenzene sulfonate, sulfonated zinc phtalocyanine and mixtures thereof.

When a bleaching agent is used, the compositions of the present invention may comprise from about 0.1% to about 50% or even from about 0.1% to about 25% bleaching agent by weight of the subject cleaning composition.

### Surfactants

The compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof.

The surfactant is typically present at a level of from about 0.1% to about 60%, from about 1% to about 50% or even from about 5% to about 40% by weight of the subject composition.

### Builders

The compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds. ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

### Chelating Agents

The compositions herein may contain a chelating agent. Suitable chelating agents include copper, iron and/or manganese chelating agents and mixtures thereof.

When a chelating agent is used, the composition may comprise from about 0.1% to about 15% or even from about 3.0% to about 10% chelating agent by weight of the subject composition.

### Dye Transfer Inhibiting Agents

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in a subject composition, the dye transfer inhibiting agents may be present at levels from about 0.0001% to about 10%, from about 0.01% to about 5% or even from about 0.1% to about 3% by weight of the composition.

### Dispersants

The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

### Enzymes

The compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that comprises a protease, lipase, cutinase and/or cellulase in conjunction with amylase.

When present in a cleaning composition, the aforementioned adjunct enzymes may be present at levels from about 0.00001% to about 2%, from about 0.0001% to about 1% or even from about 0.001% to about 0.5% enzyme protein by weight of the composition.

### Enzyme Stabilizers

Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor can be added to further improve stability.

### Catalytic Metal Complexes

Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminium cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of a macropolycyclic rigid ligand—abbreviated as “MRL”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include , for example, manganese, iron and chromium. Suitable MRL's include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

### Solvents

Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

### Hueing Dye

The liquid laundry detergent composition may comprise a hueing dye. The hueing dyes employed in the present laundry care compositions may comprise polymeric or non-polymeric dyes, organic or inorganic pigments, or mixtures thereof. Preferably the hueing dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are may be preferred.

The hueing dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C₂-C₄ alkyleneoxy groups, sometimes called alkoxy groups, preferably derived from C₂-C₄ alkylene oxide. The repeat units may be C₂-C₄ alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

### Perfume Delivery Technologies

The fluid fabric enhancer compositions may comprise one or more perfume delivery technologies that stabilize and enhance the deposition and release of perfume ingredients from treated substrate. Such perfume delivery technologies can also be used to increase the longevity of perfume release from the treated substrate. Perfume delivery technologies, methods of making certain perfume delivery technologies and the uses of such perfume delivery technologies are disclosed in US 2007/0275866 A1.
In one aspect, the fluid fabric enhancer composition may comprise from about 0.001% to about 20%, or from about 0.01% to about 10%, or from about 0.05% to about 5%, or even from about 0.1% to about 0.5% by weight of the perfume delivery technology. In one aspect, said perfume delivery technologies may be selected from the group consisting of: perfume microcapsules, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof:
In one aspect, said perfume delivery technology may comprise microcapsules formed by at least partially surrounding a benefit agent with a wall material. Said benefit agent may include materials selected from the group consisting of perfumes such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, alpha-damascone, beta-damascone, gamma-damascone, beta-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and beta-dihydro ionone, linalool, ethyllinalool, tetrahydrolinalool, and dihydromyrcenol; silicone oils, waxes such as polyethylene waxes; essential oils such as fish oils, jasmine, camphor, lavender; skin coolants such as menthol, methyl lactate; vitamins such as Vitamin A and E; sunscreens; glycerine; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, N.J., USA, International Flavors & Fragrances Corp. of South Brunswick, N.J., USA, or Quest Corp. of Naarden, Netherlands. In one aspect, the microcapsule wall material may comprise: melamine, polyacrylamide, silicones, silica, polystyrene, polyurea, polyurethanes, polyacrylate based materials, gelatin, styrene malic anhydride, polyamides, and mixtures thereof. In one aspect, said melamine wall material may comprise melamine crosslinked with formaldehyde, melamine-dimethoxyethanol crosslinked with formaldehyde, and mixtures thereof. In one aspect, said polystyrene wall material may comprise polyestyrene cross-linked with divinylbenzene. In one aspect, said polyurea wall material may comprise urea crosslinked with formaldehyde, urea crosslinked with gluteraldehyde, and mixtures thereof. In one aspect, said polyacrylate based materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof. In one aspect, the perfume microcapsule may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, and combinations thereof. Suitable deposition aids are described above and in the section titled “Deposition Aid”. In one aspect, the microcapsule may be a perfume microcapsule. In one aspect, one or more types of microcapsules, for example two microcapsules types having different perfume benefit agents may be used.

In one aspect, said perfume delivery technology may comprise an amine reaction product (ARP) or a thio reaction product. One may also use “reactive” polymeric amines and or polymeric thios in which the amine and/or thio functionality is pre-reacted with one or more PRMs to form a reaction product. Typically the reactive amines are primary and/or secondary amines, and may be part of a polymer or a monomer (non-polymer). Such ARPs may also be mixed with additional PRMs to provide benefits of polymer-assisted delivery and/or amine-assisted delivery. Nonlimiting examples of polymeric amines include polymers based on polyalkylimines, such as polyethyleneimine (PEI), or polyvinylamine (PVAm). Nonlimiting examples of monomeric (non-polymeric) amines include hydroxyl amines, such as 2-aminoethanol and its alkyl substituted derivatives, and aromatic amines such as anthranilates. The ARPs may be premixed with perfume or added separately in leave-on or rinse-off applications. In another aspect, a material that contains a heteroatom other than nitrogen and/or sulfur, for example oxygen, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols. The benefit may include improved delivery of perfume as well as controlled perfume release. Suitable ARPs as well as methods of making same can be found in USPA 2005/0003980 A1 and U.S. Pat. No. 6,413,920 B1.

Processes of Making Cleaning and/or Treatment Compositions

The cleaning compositions of the present invention can be formulated into any suitable form and prepared by any process chosen by the formulator, non-limiting examples of which are described in Applicants examples and in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use

The products of the present invention may be used in any conventional manner. In short, they may be used in the same manner as consumer products that are designed and produced by conventional methods and processes. For example, cleaning and/or treatment compositions of the present invention can be used to clean and/or treat a situs inter alia a surface or fabric. Typically at least a portion of the situs is contacted with an embodiment of Applicants' composition, in neat form or diluted in a wash liquor, and then the situs is optionally washed and/or rinsed. For purposes of the present invention, washing includes but is not limited to, scrubbing, and mechanical agitation. The fabric may comprise any fabric capable of being laundered in normal consumer use conditions. Cleaning solutions that comprise the disclosed cleaning compositions typically have a pH of from about 5 to about 10.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric mass ratio is typically from about 1:1 to about 100:1.

### EXAMPLES

The ODT model requires the execution of the winMolconn program, version 1.0.1.3 (Hall Associates Consulting, http://www.molconn.com/products.html). The following is a generic description of how to execute the program and generate the required descriptors.

Computing Molecular Structure Descriptors using winMolconn:
1) Assemble the molecular structure for one or more perfume ingredients in the form of a MACCS Structure-Data File, also called an SDF file, or as a SMILES file
2) Using version 1.0.1.3 of the winMolconn program, running on an appropriate computer, compute the full complement of molecular descriptors that are available from the program, using the SDF or SMILES file described above as input.
   a. The output of winMolconn is in the form of an ASCII text file, typically space delimited, containing the structure identifiers in the first column and respective molecular descriptors in the remaining columns for each structure in the input file.
3) Parse the text file into columns using Excel or some other appropriate technique. Each column contains a single descriptor value for each of the molecular structures in the input. The molecular descriptor labels are found on the first row of the resulting table.
4) Find and extract the descriptor columns, identified by the molecular descriptor label, corresponding to the inputs required for the model.
   a. Note that the winMolconn molecular descriptor labels are case-sensitive.

The Odor Detection Threshold (ODT) model may be in the form of a computational neural network (CNN). The model described herein is a set of 10 separate neural networks implemented in Java (version 1.7) embodied in a single Java class object. The ODT value computed by the model is the arithmetic average of the results obtained from the 10 separate networks. The ODT is reported in the form of the olfactory power (p.ol) which is the negative base-10 logarithm of the concentration (volume/volume) of an odorant in air which can be detected by a human observer. The p.ol value can be transposed to commonly used units such as ppm(volume) and ppb(volume): a p.ol value of 6.0 corresponds to 1 ppm, and a p.ol value of 9.0 corresponds to 1 ppb.

In order to execute the ODT model described in the examples below it is necessary to wrap the model class with a Java main class that will create the necessary inputs for the model class, instantiate and execute the class, and then retrieve and report the result. The CNN model class has an associated Descriptor class that is needed to provide the model inputs to the CNN in the proper order. The Java main class should instantiate the respective descriptor class, add the required winMolconn descriptors to the descriptor class instance, and then pass that instance of the descriptor class to the CNN instance as an argument.

### Computing the Odor Detection Threshold:

1) Create a Java main executable class that will create and access instances of the ODTNeuralNetworksDescriptors and ODTNeuralNetworks classes provided herein.
2) For each perfume raw material of interest:
   a. Using the winMolconn program (version 1.0.1.3), compute the full complement of available molecular descriptors.
   b. From the output of winMolconn, extract values of the following molecular descriptors: nasS, Hmax, fw, xc3, numHBa, e2C3O1s, e1C3O1d, SssCH2, xv1, SHBa, nasO, e2C2O1, nasC, SHHBd, nrbond, nelem, SsCH3, eaC2C2a, e1C3O1a, SHCsatu, Qv, nvx. Note that these descriptor labels are case-sensitive.
   c. Within a Java main executable program, create an instance of the ODTNeuralNetworksDescriptors class.
   d. Using the setter methods of the ODTNeuralNetworksDescriptors instance, set the values of all of the descriptors listed in step 2b.
   e. Within the same Java main executable program, create an instance of the ODTNeuralNetworks class, using the instance of the ODTNeuralNetworksDescriptors created in step 2d as a parameter argument.
   f. Within the same Java main executable program, retrieve the computed odor detection threshold value for the given perfume raw material by calling the getODTModelResult( ) method on the ODTNeuralNetworks instance created in step 2e.

### EXAMPLE CALCULATIONS

### Example 1

### Selecting Perfume Ingredients Having a Computed ODT of at Least 1 ppb (Volume/Volume)

The structures of the following perfume raw materials (PRMs) are entered into a ChemBioFinder™ database by sketching or by importing the structures from a compatible file format: 3-hydroxy-2-methyl-4H-pyran-4-one; acetophenone; 4-methoxybenzaldehyde; methyl 2-hydroxybenzoate; 1-methoxy-4-methylbenzene; octanal; benzyl acetate; isopentyl butyrate; 4-(4-hydroxyphenyl)butan-2-one; (R)-2-methyl-5-(prop-1-en-2-yl)cyclohex-2-en-1-one; (1R,5S)-2,6,6-trimethylbicyclo[3.1.1]hept-2-ene; (S)-3,7-dimethyloct-6-enenitrile; (1R,2R,4R)-1,3,3-trimethylbicyclo[2.2.1]heptan-2-ol; (S)-3,7-dimethylocta-1,6-dien-3-ol; (Z)-3,7-dimethylocta-2,6-dien-1-ol; allyl 2-(isopentyloxy)acetate; (S)-3,7-dimethyloct-6-en-1-ol; (S)-7-hydroxy-3,7-dimethyloctanal; 2-methoxynaphthalene; 2-methyl-4-phenylbutan-2-ol; (2Z,5E)-5,6,7-trimethylocta-2,5-dien-4-one; 1-(naphthalen-2-yl)ethan-1-one; ethyl (2S,3R)-3-methyl-3-phenyloxirane-2-carboxylate; ethyl (R)-2,6,6-trimethylcyclohexa-2,4-diene-1-carboxylate; (S)-2-(4-methylcyclohex-3-en-1-yl)propan-2-yl acetate; dodecanenitrile; (S)-3-(3-isopropylphenyl)butanal; (Z)-1-((1R,2R)-2,6,6-trimethylcyclohex-3-en-1-yl)but-2-en-1-one; (Z)-4-(2,6,6-trimethylcyclohex-1-en-1-yl)but-3-en-2-one; 3-(3,3-dimethyl-2,3-dihydro-1H-inden-5-yl)propanal; (R)-3-(4-(tert-butyl)phenyl)-2-methylpropanal; (R)-3,7-dimethylocta-1,6-dien-3-yl isobutyrate; oxacyclohexadecan-2-one; (R)-3-methylcyclopentadecan-1-one; 2-((R)-1-((R)-3,3-dimethylcyclohexyl)ethoxy)-2-methylpropyl propionate. The set of structures are exported in the form of a MACCS structure-data file (SDF) formatted text file. The program winMolconn (version 1.0.1.3) is used to compute the following set of molecular structure descriptors: nasS, Hmax, fw, xc3, numHBa, e2C3O1s, e1C3O1d, SssCH2, xv1, SHBa, nasO, e2C2O1, nasC, SHHBd, nrbond, nelem, SsCH3, eaC2C2a, e1C3O1a, SHCsatu, Qv, nvx, where nasS is the count of sulfur atoms, Hmax is the highest atom level HE-State (site of the most polar hydrogen atom), fw is the formula weight of the structure, xc3 is the 3^{rd}-order cluster molecular connectivity index, numHBa is the count of hydrogen-bond accepting atoms, e2C3O1s is the sum of bond-type electrotopological state indexes for double bonds between an oxygen atom and a carbon atom attached to two other non-hydrogen atoms, e1C3O1d is the sum of bond-type electrotopological state indexes for single bonds between an hydroxyl oxygen atom and an sp² carbon atom attached to two other non-hydrogen atoms, SssCH2 is the sum of the electrotopological state index values for methylene (—CH₂—) carbon atoms, xv1 is the valence-corrected 1^{st}-order molecular connectivity index, SHHBa is the sum of electrotopological state index values for all hydrogen bond accepting atoms in the molecule, nasO is the count of oxygen atoms, e2C2O1 is the sum of the electrotopological state indexes for double bonds between an oxygen atom and a carbon atom attached to one hydrogen atom and one non-hydrogen atom, nasC is the count of carbon atoms, SHHBd is the sum of the hydrogen atom electrotopological state indexes for all hydrogen atoms on hydrogen-bond donating atoms, nrbond is the count of rotatable bonds, nelem is the count of element types, SsCH3 is the sum of the electrotopological state indexes for the methyl-group (—CH₃) carbon atoms, eaC2C2a is the cum of bond-type electrotopological state indexes for aromatic bonds between two unsubstituted aromatic carbon atoms, e1C3O1a is the sum of bond-type electrotopological state indexes for single bonds between a hydroxyl oxygen atom and an aromatic ring carbon atom, SHCsatu is the sum of the hydrogen atom electrotopological state indexes for hydrogen atoms on sp³ carbons that are also bonded to sp² carbon atoms, Qv is the electrotopological state polarity index, and nvx is the count of graph vertices (a count of non-hydrogen atoms). Using an executable Java main class program, the following steps are executed: 1) a new instance of the ODTNeuralNetworksDescriptors class is instantiated and the winMolconn descriptor values for one PRM molecular structure are stored in the instance using the setter methods corresponding to each descriptor, 2) a new instance of the ODTNeuralNetworks is created using the instance of the ODTNeuralNetworksDescriptors class created in step 1 as an argument, and 3) the result of the ODT calculation is retrieved from the ODTNeuralNetworks instance using the getODTModelResult( )method call. Steps 1-3 are repeated for each PRM molecular structure. The results are examined and any PRM having a computed p.ol value of 9.0 (1.0 ppb, volume/volume) is selected.

| | Computed Odor |
|---|---|
| | Detection |
| | Threshold |
| PRM Chemical Name | (p.ol, vol/vol) |
| (1R,5S)-2,6,6-trimethylbicyclo[3.1.1]hept-2-ene | 6.26 |
| 3-hydroxy-2-methyl-4H-pyran-4-one | 7.15 |
| (S)-7-hydroxy-3,7-dimethyloctanal | 7.16 |
| methyl 2-hydroxybenzoate | 7.46 |
| acetophenone | 7.47 |
| benzyl acetate | 7.53 |
| (S)-3,7-dimethylocta-1,6-dien-3-ol | 7.66 |
| isopentyl butyrate | 7.66 |
| 4-(4-hydroxyphenyl)butan-2-one | 7.67 |
| 1-methoxy-4-methylbenzene | 7.67 |
| oxacyclohexadecan-2-one | 7.71 |
| 4-methoxybenzaldehyde | 7.72 |
| allyl 2-(isopentyloxy)acetate | 7.80 |
| (R)-2-methyl-5-(prop-1-en-2-yl)cyclohex-2-en-1-one | 7.83 |
| (1R,2R,4R)-1,3,3-trimethylbicyclo[2.2.1]heptan-2-ol | 7.93 |
| 2-methyl-4-phenylbutan-2-ol | 7.94 |
| (S)-3,7-dimethyloct-6-enenitrile | 7.97 |
| (R)-3-methylcyclopentadecan-1-one | 8.07 |
| (S)-3,7-dimethyloct-6-en-1-ol | 8.37 |
| (R)-3-(4-(tert-butyl)phenyl)-2-methylpropanal | 8.49 |
| ethyl (R)-2,6,6-trimethylcyclohexa-2,4-diene- | 8.53 |
| 1-carboxylate | |
| dodecanenitrile | 8.56 |
| (2Z,5E)-5,6,7-trimethylocta-2,5-dien-4-one | 8.61 |
| (S)-2-(4-methylcyclohex-3-en-1-yl)propan-2-yl acetate | 8.61 |
| octanal | 8.68 |
| (S)-3-(3-isopropylphenyl)butanal | 8.72 |
| (Z)-4-(2,6,6-trimethylcyclohex-1-en-1-yl)but-3- | 9.02 |
| en-2-one | |
| 2-methoxynaphthalene | 9.05 |
| 1-(naphthalen-2-yl)ethan-1-one | 9.08 |
| (R)-3,7-dimethylocta-1,6-dien-3-yl isobutyrate | 9.09 |
| (Z)-3,7-dimethylocta-2,6-dien-1-ol | 9.36 |
| ethyl (2S,3R)-3-methyl-3-phenyloxirane-2-carboxylate | 9.43 |
| (Z)-1-((1R,2R)-2,6,6-trimethylcyclohex-3-en-1-yl)but- | 9.44 |
| 2-en-1-one | |
| 3-(3,3-dimethyl-2,3-dihydro-1H-inden-5-yl)propanal | 9.53 |
| 2-((R)-1-((R)-3,3-dimethylcyclohexyl)ethoxy)-2- | 10.03 |
| methylpropyl propionate | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method comprising:
a.) using an ODT value determined by mathematical modelling to select one or more perfume raw materials;
b.) combining and/or processing said one or more perfume raw materials with one or more additional materials to form a product.

2. The method of claim 1, wherein said product is a consumer product.

3. The method of claim 2 wherein said mathematical modelling comprises a technique selected from the group consisting of multiple linear regression, genetic function method, generalized simulated annealing, principal components regression, non-linear regression, projection to latent structures regression, neural networks, support vector machines, logistic regression, ridge regression, cluster analysis, discriminant analysis, decision trees, nearest-neighbor classifier, molecular similarity analysis, and combinations thereof.

4. The method of claim 3 wherein said mathematical modelling comprises a technique selected from the group consisting of multiple linear regression, genetic function method, generalized simulated annealing, principal components regression, non-linear regression, projection to latent structures regression, neural networks, support vector machines, logistic regression, ridge regression and combinations thereof.

5. The method of claim 4 wherein said mathematical modelling comprises a technique selected from the group consisting of non-linear regression, projection to latent structures regression, neural networks and combinations thereof.

6. The method of claim 5 wherein said mathematical modelling comprises neural networks.

7. The method of claim 6 wherein said mathematical modelling comprises entering molecular descriptors into a neural network.

8. The method of claim 1 wherein said mathematical modelling provides an ODT value that is a numerical value having units of volume/volume.

9. The method of claim 1 wherein said mathematical modelling is sufficiently accurate to provide an ODT value of 1 ppb or greater.

10. The method of claim 8 wherein said mathematical modelling is sufficiently accurate to provide an ODT value of 1 ppb or greater.

11. The method of claim 1 wherein said one or more additional materials is selected from the group consisting of surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume and perfume delivery systems, structure elasticizing agents, thickeners/structurants, fabric softeners, carriers, hydrotropes, oligoamines, processing aids, hueing agents, pigments and mixtures thereof.

12. The method of claim 2 wherein said consumer product is selected from the group consisting of , baby care, beauty care, fabric & home care, family care, feminine care, health care, snack and/or beverage products or devices.

13. The method of claim 1, wherein the method uses the source code ODTNeuralNetworks and ODTNeuralNetworksDescriptors.

14. A consumer product produced by the method of claim 2.
